(19) United States
(12) Patent Application Publication
(10) Pub. No.: US 2026/0225822 A1
(43) Pub. Date: Aug. 6, 2026

(54) Delivery System, Building, and Distribution System

(71) Applicant: SoftBank Group Corp., Tokyo (JP)

(72) Inventor: Masayoshi Son, Minato-ku, Tokyo (JP)

(21) Appl. No.: 19/159,591

(22) PCT Filed: Feb. 6, 2024
(86) PCT No.: PCT/JP2024/003972

§ 371 Date: Aug. 25, 2025

(30) Foreign Application Priority Data
Feb. 28, 2023 (JP) 2023-029479
May 31, 2023 (JP) 2023-090444
May 31, 2023 (JP) 2023-090445

(51) Int. Cl. B65G 43/00; G06K 7/14; G06Q 10/083

(52) U.S. Cl. CPC B65G 43/00; G06K 7/1417; G06Q 10/083

(57) ABSTRACT

A delivery system automatically delivers a delivery object to each of plural dwellings in a building through a conveyance lane provided in the building. The delivery system includes a control unit that moves a delivery object that is being delivered through the conveyance lane from the conveyance lane to a delivery object yard provided in a dwelling that is a destination of the delivery object in a case in which the delivery object that is being delivered through the conveyance lane passes through the delivery object yard, and a lock mechanism that locks the delivery object such that the delivery object is not detached from the conveyance lane, and unlocks the delivery object according to authentication processing. The building includes the delivery system and a conveyance lane. A distribution system includes the delivery system described above and a server that manages transportation of a delivery object using a self-driving vehicle from a logistics base outside the building to the building.

### TECHNICAL FIELD

The present disclosure relates to a delivery system, a building, and a distribution system.

### BACKGROUND ART

As disclosed in Japanese National-Phase Publication (JP-A) No. 2008-530695, a region-based intermodal traffic system is known. As disclosed in Japanese Patent Application Laid-Open (JP-A) No. 10-246005, a large city structure in which underground city tunnels covering transportation systems are arranged radially from a center to a plurality of surrounding super high-rise cities and annularly between the super high-rise cities is known.

### SUMMARY OF INVENTION

### Technical Problem

It is desired to deliver a delivery object in a short time without being stolen.

### Solution to Problem

According to a first aspect of the disclosure, a delivery system is provided. The delivery system automatically delivers a delivery object to each of a plurality of dwellings in a building through a conveyance lane provided in the building. The delivery system includes a control unit that moves a delivery object that is being delivered through the conveyance lane from the conveyance lane to a delivery object yard provided in a dwelling that is a destination of the delivery object in a case in which the delivery object that is being delivered through the conveyance lane passes through the delivery object yard, and a lock mechanism that locks the delivery object such that the delivery object is not detached from the conveyance lane, and unlocks the delivery object according to authentication processing.

The lock mechanism may include a suction member provided in the conveyance lane and a suction device that generates a suction force on the suction member, the delivery object may be sucked by the suction member and locked not to be detached from the conveyance lane at a delivery object yard different from the delivery object yard of the destination dwelling, and be unlocked according to authentication processing at the delivery object yard of the destination dwelling.

The lock mechanism may perform authentication processing by using a two-dimensional code presented by a dweller.

A destination presentation portion that presents information indicating a destination of the delivery object may be attached to the delivery object, and the control unit may perform control to reduce a conveyance speed of the conveyance lane in a case in which the information of the destination presentation portion detected by a detection unit provided around the dwelling indicates that the dwelling is the destination.

A destination presentation portion that presents information indicating a destination of the delivery object may be attached to a tray of the delivery object, and the control unit may perform control to reduce a conveyance speed of the conveyance lane in a case in which the information of the destination presentation portion detected by a detection unit provided around the dwelling indicates that the dwelling is the destination.

A rotation mechanism that rotates in a direction orthogonal to the conveyance direction may be provided at each position of the conveyance lane, and the control unit may control an extrusion device provided at a position corresponding to a delivery object yard of each of the plurality of dwellings to extrude the delivery object to the delivery object yard provided in a dwelling that is a destination of the delivery object, the extrusion device extruding the delivery object in the direction orthogonal to the conveyance direction of the conveyance lane.

A content presentation portion that presents information regarding the delivery object may be attached to the delivery object, and the control unit may control to transmit the information of the content presentation portion detected by a detection unit provided around the dwelling to a terminal of a dweller of the dwelling.

The building may be provided with a storage that temporarily stores a delivery object addressed to a dwelling in the building and includes a refrigerating facility, and in a case in which the delivery object is a food product requiring refrigeration and the delivery object is placed in the delivery object yard for a certain time or more, the control unit may return the delivery object to the conveyance lane and move the delivery object to the storage.

The building may be provided with a storage that temporarily stores a delivery object addressed to a dwelling in the building. The control unit may store the delivery object in the storage in a case in which the delivery object is unable to be placed in the delivery object yard of a dwelling that is a destination of the delivery object.

In a case in which the delivery object is able to be delivered to the delivery object yard provided in the dwelling that is a destination of the delivery object stored in the storage, the control unit may move the delivery object from the storage to the conveyance lane.

Before a delivery object addressed to a dwelling in the building is dispatched from a logistics base outside the building, the control unit may determine whether the delivery object is able to be stored in the storage, and in a case in which it is determined that the delivery object is able to be stored in the storage, the control unit may dispatch the delivery object from the logistics base.

Before a delivery object addressed to a dwelling in the building is dispatched from a logistics base outside the building, the control unit may determine whether the delivery object is able to be placed in a delivery object yard provided in a destination dwelling, and in a case in which it is determined that the delivery object is able to be stored in the delivery object yard, the control unit may dispatch the delivery object from the logistics base.

Before a delivery object addressed to a dwelling in the building is dispatched from the logistics base, the control unit may determine whether the delivery object is able to be placed in the delivery object yard on the basis of a delivery status of another delivery object addressed to the dwelling.

Before a delivery object addressed to a dwelling in the building is dispatched from the logistics base, the control unit may determine whether the delivery object is able to be placed in the delivery object yard on the basis of a delivery status of another delivery object addressed to the dwelling and a size of the delivery object yard.

Before a delivery object addressed to a dwelling in the building is dispatched from a logistics base outside the building, the control unit may further determine whether the delivery object is able to be held on the conveyance lane. The control unit may dispatch the delivery object from the logistics base in a case in which it is determined that the delivery object is able to be held on the conveyance lane.

Before a prescribed type of delivery object addressed to a dwelling in the building is dispatched from a logistics base outside the building, the control unit may inquire of a dweller of a destination dwelling whether to deliver the delivery object, and in a case in which a delivery instruction is received from the dweller, the control unit may dispatch the delivery object from the logistics base.

In a case in which a dispatch object is dispatched from the dwelling, the control unit may move the dispatch object placed in the delivery object yard from the delivery object yard to the conveyance lane.

The lock mechanism may be coupled to a guide member provided along the conveyance lane.

In a second aspect, a building is provided. The building includes the delivery system and a conveyance lane.

The building may include a plurality of floors. The conveyance lanes may include a lifting lane for moving the delivery object between different floors of the building.

In a third aspect, a distribution system is provided. The distribution system includes the delivery system described above. The distribution system includes a server that manages transportation of a delivery object using a self-driving vehicle from a logistics base outside a building to the building.

The above summary of the invention does not enumerate all the necessary features of the disclosure. A subcombination of these feature groups can also be an invention.

### BRIEF DESCRIPTION OF DRAWINGS

FIG. 1 illustrates an overall concept of a system 10.

FIG. 2 schematically illustrates a road structure 100.

FIG. 3 schematically illustrates a connection portion between a main road 110 and a branch road 120.

FIG. 4 schematically illustrates a connection structure between a connecting road 140 and the main road 110.

FIG. 5 schematically illustrates a state in which a distribution vehicle 92 delivers a delivery object to an apartment building 80 in an elevation view.

FIG. 6 schematically illustrates disposition of a dwelling 82 and a horizontal lane 501 in a plan view.

FIG. 7 schematically illustrates a distribution box 700.

FIG. 8 illustrates an example of a data structure of distribution information managed by a server 40.

FIG. 9 schematically illustrates a lock mechanism 900.

FIG. 10 schematically illustrates a destination presentation portion 1000.

FIG. 11 is a flowchart illustrating a flow of distribution processing executed in the system 10.

FIG. 12 is a flowchart illustrating a flow of delivery processing executed in the system 10.

FIG. 13 schematically illustrates an example of a hardware configuration of a computer 1200.

FIG. 14 is a perspective view illustrating an example of the lock mechanism 900.

FIG. 15 is a perspective view illustrating another example of the lock mechanism 900.

FIG. 16 is a perspective view illustrating still another example of the lock mechanism 900.

FIG. 17 is a plan view illustrating still another example of the lock mechanism 900.

### DESCRIPTION OF EMBODIMENTS

Hereinafter, the disclosure will be described through embodiments of the invention, but the following embodiments do not limit the invention according to the claims. Not all combinations of features described in the embodiments are essential to the solution of the invention.

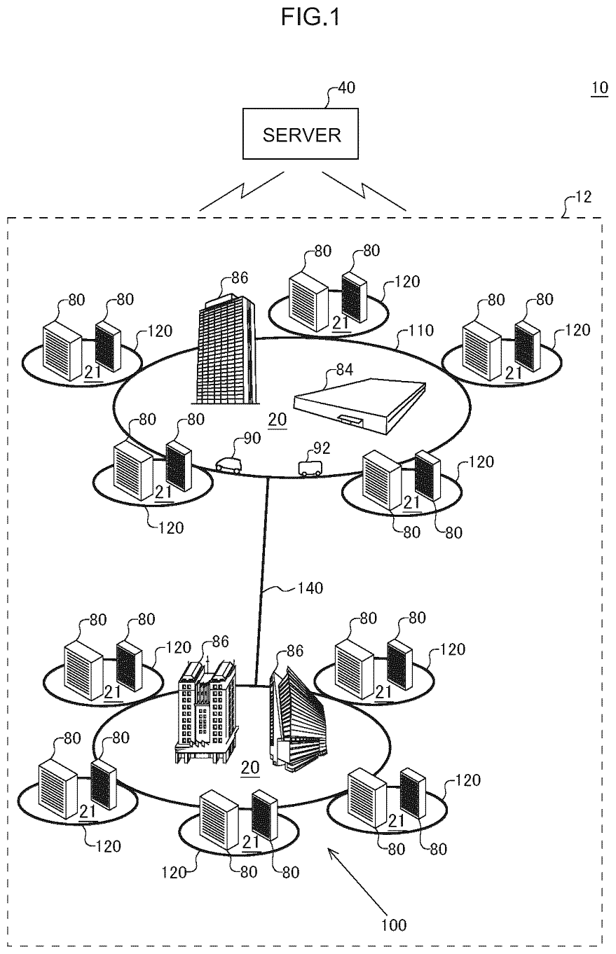

FIG. 1 illustrates the overall concept of a system 10. The system 10 includes a server 40, an urban structure 12, a taxi 90, and a distribution vehicle 92. The urban structure 12 includes a plurality of apartment buildings 80, a logistics base 84, public facilities 86, and a road structure 100. The public facilities 86 are a large-scale commercial facility, a government facility, a waste disposal site, and the like.

The road structure 100 is a road dedicated to self-driving. The road structure 100 includes a main road 110, a branch road 120, and a connecting road 140. The taxi 90 is a self-driving vehicle for passenger transportation. The distribution vehicle 92 is a self-driving vehicle for package transportation. Examples of the logistics base 84 include a logistics warehouse and a delivery food manufacturing facility.

The main road 110 is a self-driving vehicle exclusive road for high-speed traveling. The main road 110 is, for example, a road of which a reference speed is regulated to be 200 km/h. The branch road 120 is a self-driving vehicle exclusive road for medium-to-low speed traveling. The branch road 120 includes, for example, a lane of which a reference speed is regulated to be 100 km/h and a lane of which a reference speed is regulated to be 30 km/h. The apartment building 80 is provided in a living area 21 surrounded by the branch road 120.

The living area 21 is, for example, an area where humans live. The living area 21 is, for example, an area where humans dwell. A small shop may be present in the living area 21. The public facility 86 is provided in a public facility area 20 surrounded by the main road 110. The public facility area 20 is an area where humans do not dwell in principle. As will be described later, neither an intersection nor a traffic light is provided in the road structure 100. As will be described later, the road structure 100 is provided so that the taxi 90 or the distribution vehicle 92 can move between the main road 110 and the branch road 120 through a lane change.

Server 40 manages transportation services and home delivery services provided to dwellers of apartment building 80. For example, the server 40 predicts a taxi allocation demand in the urban structure 12 by using AI, and locates the taxi 90 according to the allocation demand. Upon receiving an allocation request from a dweller of the apartment building 80, the server 40 allocates the taxi 90 near the dweller.

The server 40 manages transportation of a delivery object using the distribution vehicle 92 from the logistics base 84 to the apartment building 80 as a part of the distribution system. The server 40 causes the distribution vehicle 92 to load a delivery object addressed to a dweller of the apartment building 80 at the logistics base 84, and causes the distribution vehicle 92 to distribute the delivery object to the apartment building 80. For example, upon receiving a delivery food provision request from a dweller of the apartment building 80, the server 40 causes the distribution vehicle 92 to load delivery food manufactured at a delivery food manufacturing facility that is the logistics base 84, and causes the distribution vehicle 92 to deliver the delivery food to the apartment building 80. In a case in which a package addressed to a dweller of the apartment building 80 arrives at a logistics warehouse that is the logistics base 84, the server 40 causes the distribution vehicle 92 to load the package, and causes the distribution vehicle 92 to deliver the package to the apartment building 80. As will be described later, the apartment building 80 is provided with an automatic conveyance lane for automatically delivering, to each dwelling, a delivery object such as delivery food or a package that has been delivered. As a result, a package can be automatically distributed from the logistics base 84 to each dwelling.

The road structure 100 can reduce a time taken for a dweller of the apartment building 80 to move between a living area and a public facility area or between a plurality of living areas. It is possible to deliver a delivery object from the logistics base 84 to a dwelling of a dweller of the apartment building 80 in a short time.

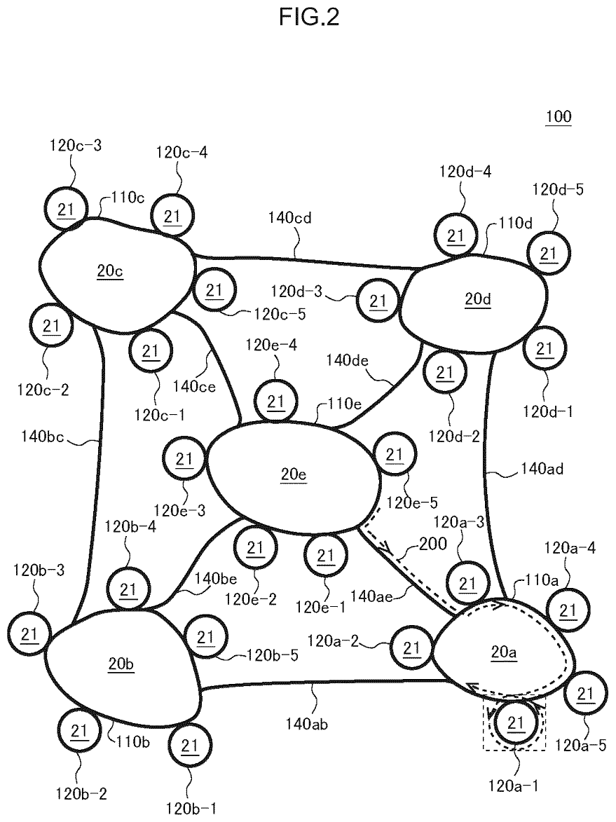

FIG. 2 schematically illustrates a road structure 100. The road structure 100 includes a main road 110a, a main road 110b, a main road 110c, a main road 110d, a main road 110e, a connecting road 140ab, a connecting road 140ae, a connecting road 140ad, a connecting road 140bc, a connecting road 140be, a connecting road 140ce, a connecting road 140cd, and a connecting road 140de. In the following description, the main road 110a, the main road 110b, the main road 110c, the main road 110d, and the main road 110e may be collectively referred to as “main road 110”.

The road structure 100 includes a branch road 120a-1, a branch road 120a-2, a branch road 120a-3, a branch road 120a-4, and a branch road 120a-5, a branch road 120b-1, a branch road 120b-2, a branch road 120b-3, a branch road 120b-4, and a branch road 120b-5, a branch road 120c-1, a branch road 120c-2, a branch road 120c-3, a branch road 120c-4, and a branch road 120c-5, a branch road 120d-1, a branch road 120d-2, a branch road 120d-3, a branch road 120d-4, and a branch road 120d-5, a branch road 120e-1, a branch road 120e-2, a branch road 120e-3, a branch road 120e-4, and a branch road 120e-5.

The branch road 120a-1, the branch road 120a-2, the branch road 120a-3, the branch road 120a-4, and the branch road 120a-5 are connected to the main road 110a. The branch road 120b-1, the branch road 120b-2, the branch road 120b-3, the branch road 120b-4, and the branch road 120b-5 are connected to the main road 110b. The branch road 120c-1, the branch road 120c-2, the branch road 120c-3, the branch road 120c-4, and the branch road 120c-5 are connected to the main road 110c. The branch road 120d-1, the branch road 120d-2, the branch road 120d-3, the branch road 120d-4, and the branch road 120d-5 are connected to the main road 110d. The branch road 120e-1, the branch road 120e-2, the branch road 120e-3, the branch road 120e-4, and the branch road 120e-5 are connected to the main road 110e. In the following description, the branch road 120a-1, the branch road 120a-2, the branch road 120a-3, the branch road 120a-4, and the branch road 120a-5, the branch road 120b-1, the branch road 120b-2, the branch road 120b-3, the branch road 120b-4, and the branch road 120b-5, the branch road 120c-1, the branch road 120c-2, the branch road 120c-3, the branch road 120c-4, and the branch road 120c-5, the branch road 120d-1, the branch road 120d-2, the branch road 120d-3, the branch road 120d-4, and the branch road 120d-5, the branch road 120e-1, the branch road 120e-2, the branch road 120e-3, the branch road 120e-4, and the branch road 120e-5 may be collectively referred to as “branch road 120”.

The main road 110a, the main road 110b, the main road 110c, the main road 110d, and the main road 110e are roads surrounding the public facility area 20a, the public facility area 20b, the public facility area 20c, the public facility area 20d, and the public facility area 20e, respectively. The public facility area is an example of a human activity area. Thus, the main road 110 is a closed road. The main road 110 is a so-called annular road. In the present embodiment, the main road 110 is assumed to be a closed road, but a form in which the main road 110 is not closed may be adopted.

The branch roads 120 respectively surround the separate living areas 21. The branch road 120 is a closed road. The branch road 120 is a so-called annular road.

The main road 110 is a road in which a traveling direction of a vehicle is regulated to be in a certain direction. The main road 110 is, for example, a road in which a traveling direction of a vehicle is regulated to be clockwise. The main road 110 is an example of a first road.

The branch road 120 is a road in which a traveling direction of a vehicle is regulated to be in a certain direction. The branch road 120 is, for example, a road in which a traveling direction of a vehicle is regulated to be counterclockwise. The branch roads 120 are examples of a second road, a third road, and a fifth road.

As illustrated by a movement route 200 in FIG. 2, a vehicle such as a taxi 90 or a distribution vehicle 92 can move from the main road 110e to the main road 110a, for example, through the connecting road 140ae, travel clockwise on the main road 110a to move to the branch road 120a-1, travel counterclockwise on the branch road 120a-1 to move to the main road 110a, and travel clockwise on the main road 110a again.

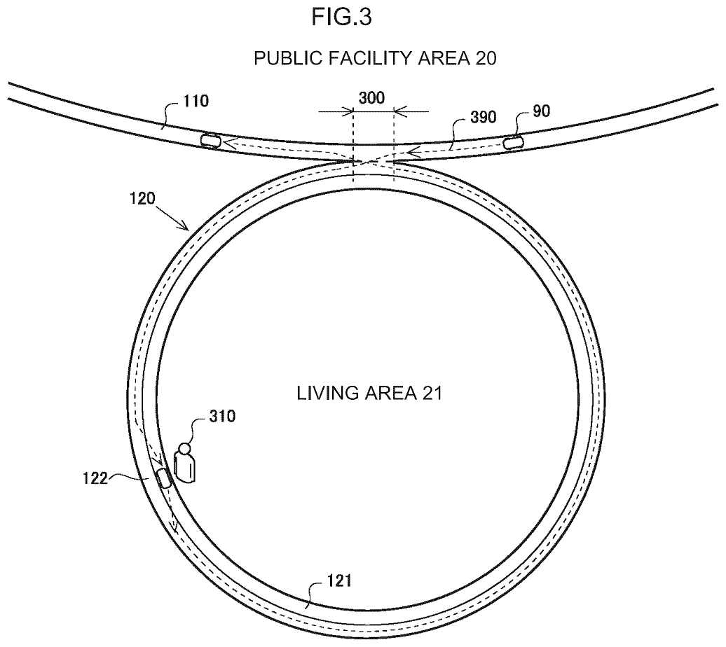

The main road 110 and the branch road 120 are connected such that a vehicle can move between the main road 110 and the branch road 120 through a lane change. A plurality of branch roads 120 are provided for one main road 110, and one main road 110 and each of the plurality of branch roads 110 provided for the main road 110 are connected such that a vehicle can move between the main road 110 and each of the plurality of branch roads 120 through a lane change. A specific example of the connection structure between the main road 110 and the branch road 120 will be described with reference to FIG. 3.

FIG. 3 schematically illustrates a connection portion between the main road 110 and the branch road 120. The main road 110 is a one-way 1-lane road. The main road 110 is, for example, a road in which the maximum speed is regulated to be 200 km/h.

The branch road 120 is a one-way multi-lane road. Specifically, the branch road 120 includes a low-speed traveling lane 121 and a medium-speed traveling lane 122. The low-speed traveling lane 121 and the medium-speed traveling lane 122 are lanes in which a traveling direction of a vehicle is regulated in a certain direction. In the low-speed traveling lane 121 and the medium-speed traveling lane 122, traveling directions of vehicles are regulated in the same direction. The low-speed traveling lane 121 is an example of a first lane, and the medium-speed traveling lane 122 is an example of a second lane.

The low-speed traveling lane 121 is a lane in which the reference speed is regulated to be 30 km/h. For example, the low-speed traveling lane 121 is a lane in which the maximum speed is regulated to be 30 km/h. The medium-speed traveling lane 122 is a lane in which the reference speed is regulated to be 100 km/h. For example, the medium-speed traveling lane 122 is a lane in which the maximum speed is regulated to be 100 km/h. As described above, the medium-speed traveling lane 122 is a lane in which a vehicle travels at a higher speed than the low-speed traveling lane 121. The main road 110 is a road on which a vehicle travels at a higher speed than the medium-speed traveling lane 122.

The main road 110 is provided outside the branch road 120. The main road 110 and the branch road 120 are connected so that a vehicle can move between the main road 110 and the medium-speed traveling lane 122 through a lane change.

The branch road 120 includes a section 300 that runs side by side with the main road 110. Specifically, the medium-speed traveling lane 122 includes the section 300 running side by side with the main road 110. The section 300 is a section where the main road 110 and the branch road 120 are in contact with each other. In the section 300, the traveling direction of a vehicle regulated in the medium-speed traveling lane 122 and the traveling direction of a vehicle regulated in the main road 110 are the same direction. Therefore, a vehicle can move from the main road 110 to the medium-speed traveling lane 122 through a lane change in the section 300. In the section 300, the vehicle can move from the medium-speed traveling lane 122 to the main road 110 through a lane change.

A movement trajectory 390 in FIG. 3 is a movement trajectory of the taxi 90. The taxi 90 changes lanes from the main road 110 to the medium-speed traveling lane 122 through self-driving and enters the branch road 120. In the case of approaching a person 310 who has requested the server 40 to dispatch a taxi through self-driving, the taxi 90 moves from the medium-speed traveling lane 122 to the low-speed traveling lane 121 and stops near the person 310. In a case in which the person 310 gets in the taxi 90, the taxi 90 starts from the low-speed traveling lane 121, changes the lane to the medium-speed traveling lane 122, and travels on the branch road 120. In the section 300, the taxi 90 moves to the main road 110 through a lane change.

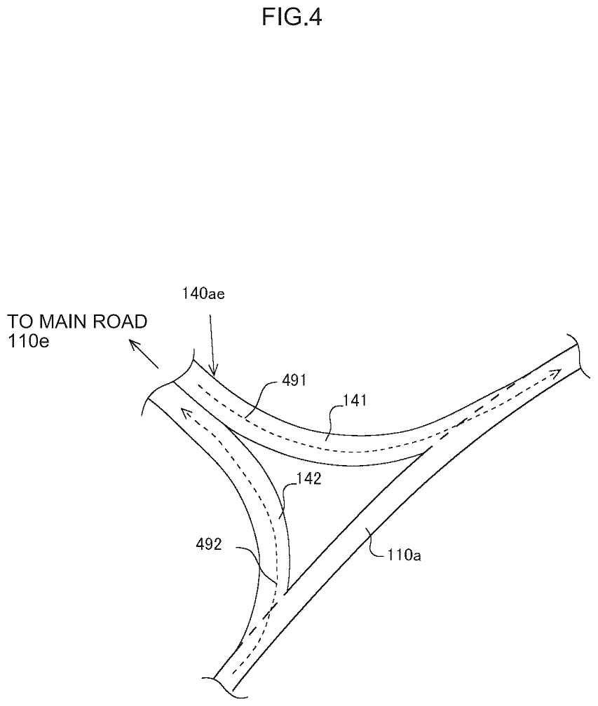

FIG. 4 schematically illustrates a connection structure between the connecting road 140 and the main road 110. Specifically, FIG. 4 schematically illustrates a connection structure between the connecting road 140ae and the main road 110a. The connecting road 140ae is a road connecting the main road 110a and the main road 110e.

The road 140ae includes a lane 141 and a lane 142. As indicated by a movement route 491 of a vehicle, the lane 141 and the main road 110a are connected such that the vehicle can move from the lane 141 to the main road 110a through a lane change. As indicated by a movement route 492 of a vehicle, the lane 142 and the main road 110a are connected such that the vehicle can move from the main road 110a to the lane 142 through a lane change.

As described above, the connecting road 140ae and the main road 110a are connected such that the vehicle can move from the connecting road 140ae to the main road 110a through a lane change. The connecting road 140ae and the main road 110a are connected such that the vehicle can move from the main road 110a to the connecting road 140ae through a lane change.

Similarly, for a connection structure between the connecting road 140ae and the main road 110e, the lane 141 and the main road 110e are connected such that a vehicle can move from the main road 110e to the lane 141 through a lane change. The lane 142 and the main road 110e are connected such that a vehicle can move from the lane 142 to the main road 110a through a lane change.

As described above, a vehicle can move between the main road 110a and the connecting road 140ae through a lane change, and can move between the main road 110e and the connecting road 140ae through a lane change. The lane 141 and the lane 142 may be provided as separate roads. One of the lane 141 and the lane 142 need not be provided on the connecting road 140ae as necessary.

As described with reference to FIGS. 1 to 4, according to the main road 110, a vehicle can move between the main road 110 and the connecting road 140 and between the main road 110 and the branch road 120 through a lane change. Therefore, it is not necessary to install a traffic light for performing traffic arrangement. Since a vehicle only needs to travel on the main road 110 and the branch road 120 in one direction, an algorithm of the self-driving control for the vehicle does not become complicated. Therefore, a vehicle can travel at a high speed while maintaining safety.

In the system 10, a plurality of types of taxis having different numbers of passengers are used as the taxis 90. A moving object is not limited to a taxi as long as the moving object is capable of carrying passengers. In the system 10, for example, all types of taxis and buses from small to large may be used, and taxis and buses having different passenger capacity such as 1 passenger, 2 passengers, 4 passengers, 8 passengers, and 50 passengers may be used. The server 40 predicts a passenger transportation demand around the road structure 100, and deploys the taxi 90 on the road structure 100 on the basis of the predicted passenger transportation demand.

The living area 21 may be a circular area. A size of the living area 21 is preferably such a size that a human can move on foot from the center of the living area 21 to the low-speed traveling lane 121. For example, the living area 21 may be, for example, an area having a radius of about 600 m to a radius of about 800 m, and this numerical value may be changed as appropriate. An area occupied by one main road 110 and the branch road 120 connected to one main road 110 may be an area of about 5 km square.

In the embodiment described above, the branch road 120 is provided outside the main road 110, and the branch road 120 is located to be substantially circumscribed with the main road 110. However, a form may be used in which the branch road 120 is provided inside the main road 110, and the branch road 120 is located to be substantially inscribed in the main road 110

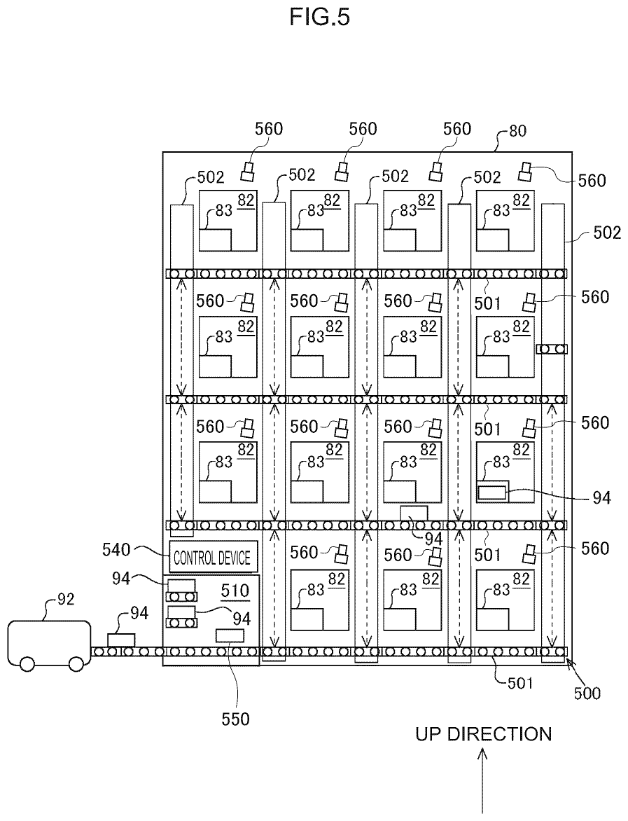

Next, a package delivery system will be described with reference to FIGS. 5 to 12. FIG. 5 schematically illustrates a state in which the distribution vehicle 92 delivers a delivery object to the apartment building 80 in an elevation view. The apartment building 80 includes a plurality of dwellings 82, a conveyance lane 500, a storage 510, and a control device 540.

The conveyance lane 500 and the dwelling 82 are provided in the apartment building 80. The conveyance lane 500 includes a horizontal lane 501 and a lifting lane 502. The apartment building 80 is an example of a building. Each of the dwellings 82 is provided with a package yard 83. The “package yard” is an example of a delivery object yard. The apartment building 80 includes a plurality of floors. In the apartment building 80, a plurality of dwellings 82 are provided over a plurality of floors.

The distribution vehicle 92 transports a delivery object 94 addressed to the dwelling 82 in the apartment building 80 from the logistics base 84 to the apartment building 80 through self-driving. In the case of arriving at the apartment building 80, the distribution vehicle 92 sends the delivery object 94 to the horizontal lane 501. The delivery object 94 sent to the horizontal lane 501 is delivered to the destination dwelling 82 by the horizontal lane 501 and the lifting lane 502.

The horizontal lane 501 may include, for example, a roller conveyor. The horizontal lane 501 may include a belt conveyor. The lifting lane 502 may include, for example, a roller conveyor provided to be movable up and down. The control device 540 delivers the delivery object 94 to the destination dwelling 82 by controlling operations of the horizontal lane 501 and the lifting lane 502.

The control device 540 configures a part of a delivery system for automatically delivering the delivery object 94 to the dwelling 82 through the conveyance lane 500. The control device 540 and the server 40 operate in cooperation with each other to function as a control unit in the delivery system.

The control device 540 moves the delivery object 94 that is being delivered through the conveyance lane 500 from the conveyance lane 500 to the package yard 83 in a case in which the delivery object 94 being delivered through the conveyance lane 500 passes through the package yard 83 provided in the dwelling 82 that is a destination of the delivery object 94. Means for moving the delivery object 94 from the conveyance lane 500 to the package yard 83 will be described later.

The storage 510 temporarily stores the delivery object 94 addressed to the dwelling 82 in the apartment building 80. The control device 540 stores the delivery object 94 in the storage 510 in a case in which the delivery object 94 cannot be placed in the package yard 83 of the dwelling 82 that is a destination of the delivery object 94. In a case in which the delivery object 94 can be delivered to the package yard 83 provided in the dwelling 82 that is a destination of the delivery object 94 stored in the storage 510, the control device 540 moves the delivery object 94 from the storage 510 to the conveyance lane 500. For example, the control device 540 stores the delivery object 94 on a movable roller conveyor in the storage 510. In the case of delivering the delivery object 94 stored in the storage 510 to the dwelling 82, the control device 540 may move the roller conveyor on which the delivery object 94 is placed to the vicinity of the horizontal lane 501, and send the delivery object 94 from the roller conveyor to the horizontal lane 501, thereby moving the delivery object 94 to the conveyance lane 500.

The storage 510 includes a refrigerating facility 550. In a case in which the delivery object 94 is a fresh product and the delivery object 94 is placed in the package yard 83 for a certain time or more, the control device 540 returns the delivery object 94 to the conveyance lane 500 and moves the delivery object 94 to the storage 510.

As described above, in a case in which the delivery object 94 is a product that requires refrigeration and a certain time has passed in a state of being placed in the package yard 83, it is determined that a dweller is absent, and the delivery object can be temporarily returned to the conveyance lane 500 and returned to the storage 510 provided with the refrigerating facility 550.

Before the delivery object 94 addressed to the dwelling 82 in the apartment building 80 is dispatched from the logistics base 84 outside the apartment building 80, the server 40 may determine whether the delivery object 94 can be stored in the storage 510, and may send the delivery object 94 from the logistics base 84 in a case in which it is determined that the delivery object 94 can be stored in the storage 510.

Before the delivery object 94 addressed to the dwelling 82 in the apartment building 80 is dispatched from the logistics base 84, the server 40 may determine whether the delivery object 94 can be placed in the package yard 83 provided in the destination dwelling 82, and may dispatch the delivery object 94 from the logistics base 84 in a case in which it is determined that the delivery object 94 can be stored in the package yard 83. For example, before the delivery object 94 addressed to the dwelling 82 in the apartment building 80 is dispatched from the logistics base 84, the server 40 may determine whether the delivery object 94 can be placed in the package yard 83 on the basis of a delivery status of another delivery object 94 addressed to the dwelling 82. Specifically, before the delivery object 94 addressed to the dwelling 82 in the apartment building 80 is dispatched from the logistics base 84, the server 40 may determine whether the delivery object 94 can be placed in the package yard 83 on the basis of a delivery status of another delivery object 94 addressed to the dwelling 82 and the size of the package yard 83. For example, in a case in which there is only a space for one delivery object 94 in the package yard 83, and another delivery object 94 addressed to the dwelling 82 is in an unreceived state, it may be determined that the delivery object 94 cannot be placed in the package yard 83. The package may be distributed as the delivery object 94 in a state of being put in a distribution box having a predetermined size. The server 40 may determine whether the delivery object 94 can be placed in the package yard 83 on the basis of the size of the distribution box and the size of the package yard 83.

Before the delivery object 94 addressed to the dwelling 82 in the apartment building 80 is dispatched from the logistics base 84 outside the apartment building 80, the server 40 may further determine whether the delivery object 94 can be held on the conveyance lane 500. In a case in which it is determined that the delivery object 94 can be held on the conveyance lane 500, the server 40 may dispatch the delivery object 94 from the logistics base 84. For example, the server 40 manages the number of delivery objects 94 on the conveyance lane 500 of the apartment building 80, and may determine that the delivery object 94 can be held on the conveyance lane 500 in a case in which the number of delivery objects 94 on the conveyance lane 500 is less than a predetermined number.

Before a prescribed type of delivery object 94 addressed to the dwelling 82 of the apartment building 80 is dispatched from the logistics base 84 outside the apartment building 80, the server 40 may inquire of a dweller of the destination dwelling 82 whether to deliver the delivery object 94, and in the case of receiving a delivery instruction from the dweller, may dispatch the delivery object 94 from the logistics base 84. For example, in a case in which the type of the delivery object 94 addressed to the dwelling 82 is a fresh product, the server 40 may inquire of the dweller of the destination dwelling 82 whether to deliver the delivery object 94. The server 40 may transmit the inquiry to a mobile terminal of the dweller of the dwelling 82 and receive a delivery instruction from the mobile terminal of the dweller. The server 40 may transmit an inquiry to a home server of the destination dwelling 82 and receive a delivery instruction of the dweller from the home server.

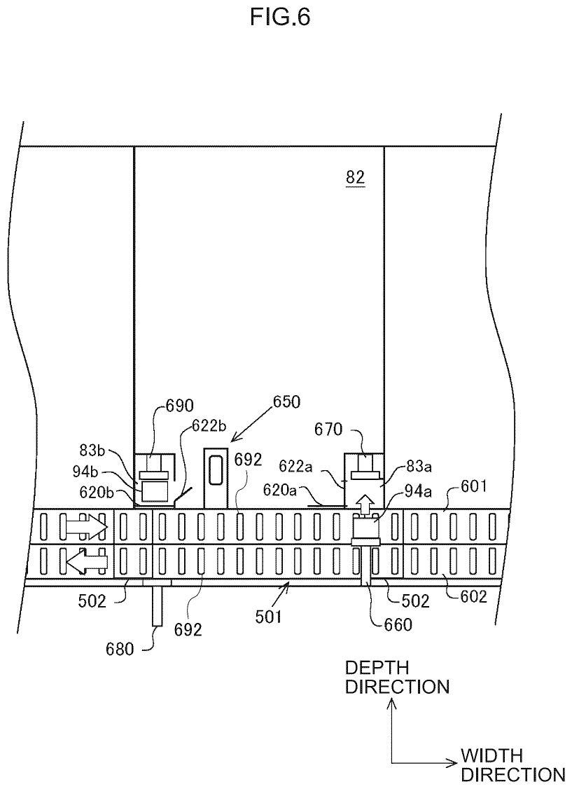

FIG. 6 schematically illustrates the disposition of the dwelling 82 and the horizontal lane 501 in a plan view. The dwelling 82 is provided with a package yard 83a and a package yard 83b. The package yard 83a is a package yard on which the delivery object 94a that is a package is placed. The package yard 83a is also a dispatch object yard on which a delivery object that is a package dispatched from the dwelling 82 is placed. The package yard 83b is a waste yard. The waste yard is a yard on which waste that is a package addressed to a waste disposal site is placed.

The delivery object 94a is distributed as a delivery object in a state in which a package is put in a predetermined distribution box. The distribution box will be described later.

The horizontal lane 501 includes a horizontal conveyance lane 601 and a horizontal conveyance lane 602 that convey the delivery object 94 in directions opposite to each other. The apartment building 80 includes an extrusion device 660 that extrudes the delivery object 94a toward the package yard 83a at a position corresponding to the package yard 83a of each dwelling 82. The apartment building 80 includes an extrusion device 680 that extrudes the distribution box toward the package yard 83b at a position corresponding to the package yard 83b of each dwelling 82.

A rotation mechanism 692 that does not rotate in the conveyance direction but rotates in a direction orthogonal to the conveyance direction is provided at each position of the horizontal conveyance lane 601 and the horizontal conveyance lane 602. The control device 540 controls the extrusion device 660 that is provided at a position corresponding to the package yard 83a of each of the plurality of dwellings 82, the extrusion device 660 extruding the delivery object 94 in the direction orthogonal to the conveyance direction of the conveyance lane 600, to extrude the delivery object 94 to the package yard 83a provided in the dwelling 82 that is a destination of the delivery object 94. In this case, in a case in which the package is pushed by the extrusion device 660, the delivery object 94 is pushed in the direction orthogonal to the conveyance direction of the conveyance lane 500, and thus the delivery object 94 can be smoothly stored in the package yard 83a by the rotation mechanism 692.

The control device 540 opens an opening/closing door 620a between the package yard 83a and the horizontal lane 501 at a timing at which the delivery object 94a addressed to the dwelling 82 reaches the package yard 83a, and drives the extrusion device 660 to extrude the delivery object 94a toward the package yard 83a. As a result, the control device 540 moves the delivery object 94a to the package yard 83a. The control device 540 closes the opening/closing door 620a in a case in which the delivery object 94 is extruded to the package yard 83a.

The dwelling 82 includes an opening/closing door 622a between the living space of the dwelling 82 and the package yard 83a for the dweller to access the package yard 83a. The dweller opens the opening/closing door 622a and takes out the package from the distribution box. In a case in which it is determined that the package has been taken out from the distribution box, the control device 540 moves the empty distribution box to the conveyance lane 500. For example, the control device 540 opens the opening/closing door 620a and drives the extrusion device 670 provided in the package yard 83a to extrude the empty distribution box toward the horizontal lane 501. As a result, the control device 540 moves the distribution box to the conveyance lane 500. The control device 540 stores the empty distribution box in the storage 510 of the apartment building 80, or delivers the empty distribution box to the logistics base 84 with the distribution vehicle 92. The control device 540 may constantly hold a predetermined number of empty distribution boxes on the conveyance lane 500.

In a case in which a package is dispatched from the dwelling 82, the dweller puts the package in a distribution box and dispatches the distribution box. Specifically, the control device 540 moves an empty distribution box to the package yard 83a through the conveyance lane 500 on the basis of a distribution request from the dweller. The dweller puts the package in the empty distribution box and enters a destination of a dispatch object. As an example, the dweller may enter a destination via a mobile terminal and register the destination in the server 40 via the mobile terminal. In a case in which the destination of the package is entered, the control device 540 moves the distribution box to the conveyance lane 500. For example, the control device 540 opens the opening/closing door 620a and drives the extrusion device 670 to extrude the distribution box toward the horizontal lane 501. As a result, the control device 540 moves the dispatch object from the dwelling 82 to the conveyance lane 500. The distribution box that is the dispatch object from the dwelling 82 is distributed to the logistics base 84 by the distribution vehicle 92, or is distributed to the dwelling 82 of another apartment building 80 by the distribution vehicle 92.

Next, a case in which waste is dispatched from the dwelling 82 to a waste disposal site will be described. The waste is put in a distribution box dedicated to waste and dispatched. In the distribution box dedicated to waste, a waste disposal site is preset as a destination.

The control device 540 opens an opening/closing door 620b between the package yard 83b and the horizontal lane 501 and drives the extrusion device 680 to extrude an empty distribution box toward the package yard 83b at a timing at which the empty distribution box dedicated to waste reaches the package yard 83a. As a result, the control device 540 moves the empty distribution box to the package yard 83b. The control device 540 closes the opening/closing door 620b in a case in which the empty distribution box is extruded to the package yard 83b.

The dwelling 82 includes the opening/closing door 622b between the living space and the package yard 83b for the dweller to access the package yard 83b. The package yard 83b is provided, for example, in the vicinity of a kitchen 650 of the dwelling 82. The dweller opens the opening/closing door 622b to put waste such as household garbage in a distribution box dedicated to waste.

Upon receiving a waste collection request from the dweller, the control device 540 moves the distribution box dedicated to waste to the conveyance lane 500. For example, the control device 540 opens the opening/closing door 620b and drives the extrusion device 690 provided in the package yard 83b to extrude the distribution box dedicated to waste toward the horizontal lane 501. As a result, the control device 540 moves the package including the waste to the conveyance lane 500. The distribution box containing the waste is distributed to a waste disposal site provided in the public facility area 20 by the distribution vehicle 92.

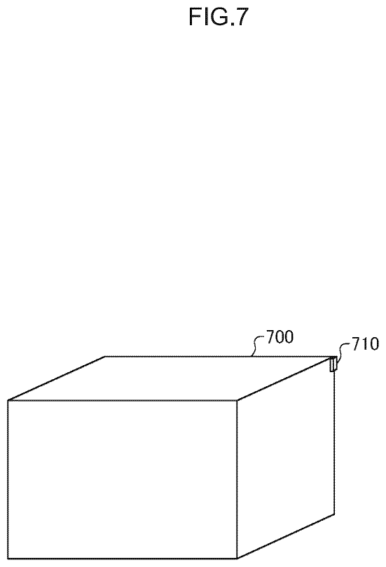

FIG. 7 schematically illustrates the distribution box 700. The distribution box 700 includes a controller 710. The controller 710 stores identification information of the distribution box 700. The controller 710 has a function of detecting whether a package is in the distribution box 700. The controller 710 may detect whether a package is in the distribution box 700 by analyzing an image acquired by a camera provided in the distribution box 700.

The server 40 manages position information of the distribution box 700 in real time. For example, the controller 710 has a wireless communication function, and transmits status information including the current position of the distribution box 700, identification information of the distribution box 700, and information indicating whether a package is in the distribution box 700 to the server 40 through wireless communication. The controller 710 may have a function of transmitting status information by using a near field communication function. In this case, in the case of receiving the status information transmitted from the distribution box 700, the home server of the dwelling 82 or the mobile terminal of the dweller, the control device 540, or the distribution vehicle 92 may transfer the status information to the server 40.

In a case in which the dweller of the dwelling 82 puts a package into the distribution box 700 and dispatches the package, and the dweller enters a destination into the mobile terminal, the controller 710 transmits identification information of the distribution box 700 to the mobile terminal. The mobile terminal of the dweller transmits a dispatch request including the identification information of the distribution box 700, the destination, the type of package loaded in the distribution box 700, and identification information of the dweller to the server 40. Upon receiving the dispatch request, the server 40 manages the identification information of the distribution box 700 and the destination and the type of cargo in association with each other, and instructs the control device 540 to dispatch the distribution box 700 from the package yard 83a of the dwelling 82 corresponding to the identification information of the dweller.

Next, a case in which the distribution box 700 is a distribution box dedicated to waste will be described. In a case in which the dweller performs an operation of requesting collection of waste with the mobile terminal, the mobile terminal transmits a waste collection instruction including the identification information of the dweller to the server 40. Upon receiving the waste collection instruction, the server 40 instructs the control device 540 to dispatch the distribution box 700 from the package yard 83b of the dwelling 82 corresponding to the identification information of the dweller.

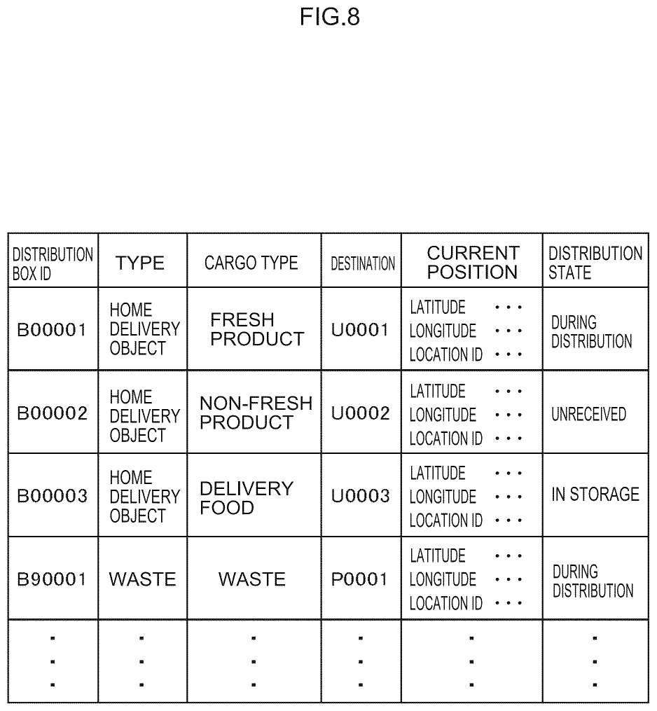

FIG. 8 illustrates an example of a data structure of distribution information managed by the server 40. The server 40 manages a distribution box ID, the type of a distribution box, a cargo type, a destination, the current position, and the distribution state in association with each other.

The “distribution box ID” is identification information of the distribution box 700. The “type” is information indicating the type of the distribution box 700. The “type” is information indicating one of “home delivery object” and “waste”. The “cargo type” indicates the type of a package placed in the distribution box 700. In a case in which the distribution box 700 is a distribution box dedicated to waste, “waste” is fixedly set in advance in the “type” and “cargo type”.

In a case in which the distribution box 700 is not a distribution box dedicated to waste, information indicating “home delivery object” is fixedly set in advance in the “type”. In the “cargo type”, a “fresh product”, a “non-fresh product”, and “delivery food” are set according to the type of a distribution object put in the distribution box 700. The “fresh product” indicates, for example, that the delivery object requires quality maintenance measures, such as refrigeration or freezing. The “non-fresh product” indicates that the delivery object does not require quality maintenance measures such as refrigeration or freezing. The “delivery food” indicates that the delivery object is delivery food.

The “destination” is identification information of a delivery destination of the distribution box 700. The “current position” is information indicating the current position of the distribution box 700. The “distribution state” is information indicating a distribution state of the distribution box 700. The server 40 registers the “destination” on the basis of a dispatch request from the portable terminal of the dweller. The server 40 updates the “current position” and the “distribution state” in real time on the basis of the status information transmitted from the distribution box 700.

The “current position” includes geographic information such as latitude information and longitude information. The “current position” may include logical information for specifying the current position of the distribution box 700, such as identification information of the distribution vehicle 92, identification information of the apartment building 80, and identification information of the dwelling 82, in addition to the geographical information.

The distribution state includes information such as “not dispatched”, “during distribution”, “unreceived”, “received”, “in storage”, and “not used”. “Not dispatched” indicates a state in which the distribution box 700 has not been dispatched. “Not dispatched” indicates a state in which the distribution box 700 has not been dispatched from the logistics base 84 or a state in which the distribution box 700 has not been dispatched from the package yard 83 of the dwelling 82.

“During distribution” indicates a state in which the distribution box 700 is dispatched from the logistics base 84 or the package yard 83 to be delivered to a destination and is not stored in the storage 510. “Unreceived” indicates a state in which the distribution box 700 is at the package yard 83 and a package is in the distribution box 700. “Received” indicates a state in which the distribution box 700 is in the package yard 83 and no package is in the distribution box 700. “In storage” indicates a state in which the distribution box 700 is stored in the storage 510. “Not used” indicates a state in which the distribution box 700 is not used for distribution. For example, “not used” indicates a state in which the distribution box 700 is stored in an empty state in the storage 510, the logistics base 84, or the like.

Next, a configuration for preventing theft of the delivery object 94 will be described.

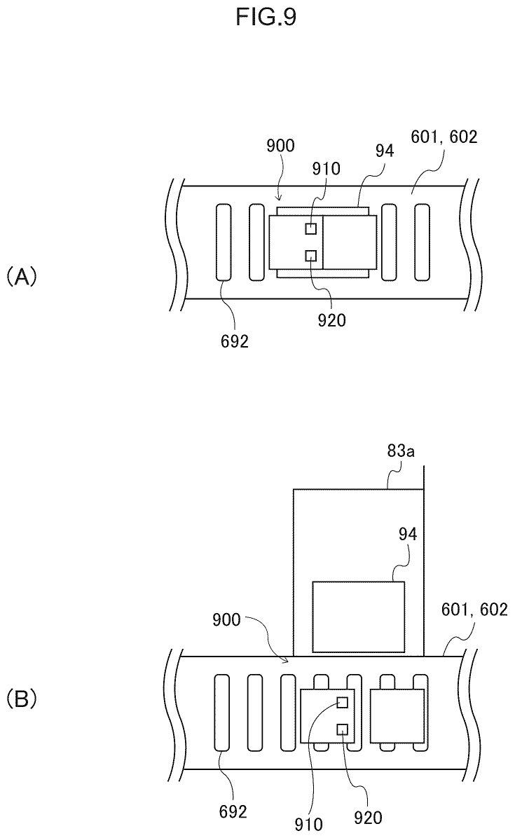

As illustrated in FIG. 9(A), the horizontal conveyance lane 601 and the horizontal conveyance lane 602 include a lock mechanism 900 that locks the delivery object 94 so as not to be detached from the horizontal conveyance lane 601 and the horizontal conveyance lane 602, and the lock mechanism 900 performs unlocking in accordance with authentication processing. The lock mechanism 900 includes a lock control unit 910 and a reading unit 920. The reading unit 920 reads a two-dimensional code (for example, a QR code (registered trademark)) presented by the dweller. The lock control unit 910 performs authentication processing of collating the read information of the two-dimensional code with information prescribed for the delivery object 94 to be gripped by the lock mechanism 900. Specifically, while the delivery object 94 is being conveyed in the horizontal conveyance lane 601 or the horizontal conveyance lane 602, the dweller of the destination dwelling 82 presents the two-dimensional code (for example, a two-dimensional code displayed in a message received from the server 40) acquired in advance for the delivery object 94 to the reading unit 920 of the lock mechanism 900 that grips the delivery object 94, thereby performing the authentication processing.

The lock mechanism 900 is configured such that the delivery object 94 is gripped by two parts divided in the conveyance direction, and the delivery object 94 cannot be opened in the gripped state.

The lock mechanism 900 is configured to be conveyed by the horizontal conveyance lane 601 or the horizontal conveyance lane 602 together with the delivery object 94 in a state of being attached to the horizontal conveyance lane 601 or the horizontal conveyance lane 602.

In a case in which the authentication processing is successful, the lock control unit 910 performs unlocking of the lock mechanism 900. As described above, the delivery object 94 conveyed on the horizontal conveyance lane 601 and the horizontal conveyance lane 602 is not detachable from the horizontal conveyance lane 601 and the horizontal conveyance lane 602 by being gripped by the lock mechanism 900, and a third party cannot take the delivery object 94 from the horizontal conveyance lane 601 and the horizontal conveyance lane 602 unless an owner performs collation using a two-dimensional code and performs unlocking.

As illustrated in FIG. 9(B), the control device 540 performs unlocking of the lock mechanism 900 immediately before the delivery object 94 is extruded to the package yard 83a, and the delivery object 94 is extruded to the package yard 83a by the extrusion device 660.

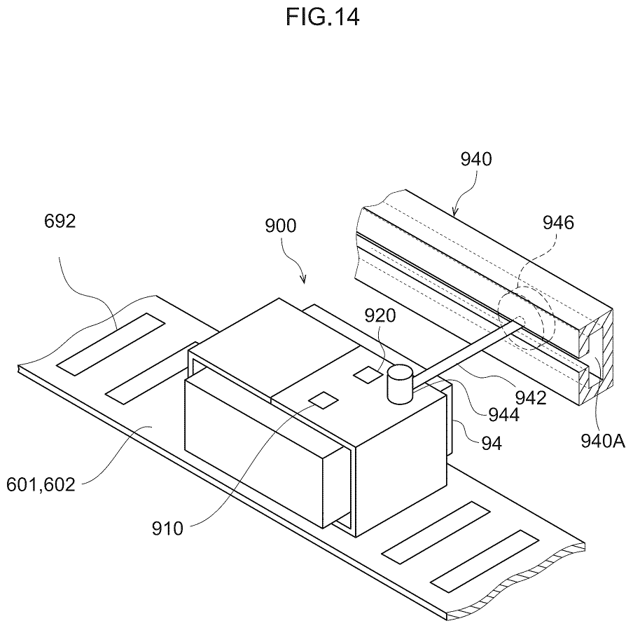

As illustrated in FIG. 14, the lock mechanism 900 may be configured by connecting two parts for gripping the delivery object 94 to a guide member 940 provided along the horizontal conveyance lane 601 and the horizontal conveyance lane 602 via a lock member 942. The lock member 942 includes, for example, a bar-shaped member or a cable. One end 944 of the lock member 942 is coupled to one of the two parts that grip the delivery object 94. The one end 944 may be pivotably coupled to the two parts. A coupling position of the one end 944 of the lock member 942 in the two parts gripping the delivery object 94 is not limited to the illustrated position.

The other end 946 of the lock member 942 is formed in, for example, a disk shape, is fitted into a guide groove 940A (T slot) of the guide member 940, and slides in the guide groove 940A along with movement of the delivery object 94 on the horizontal conveyance lane 601 and the horizontal conveyance lane 602.

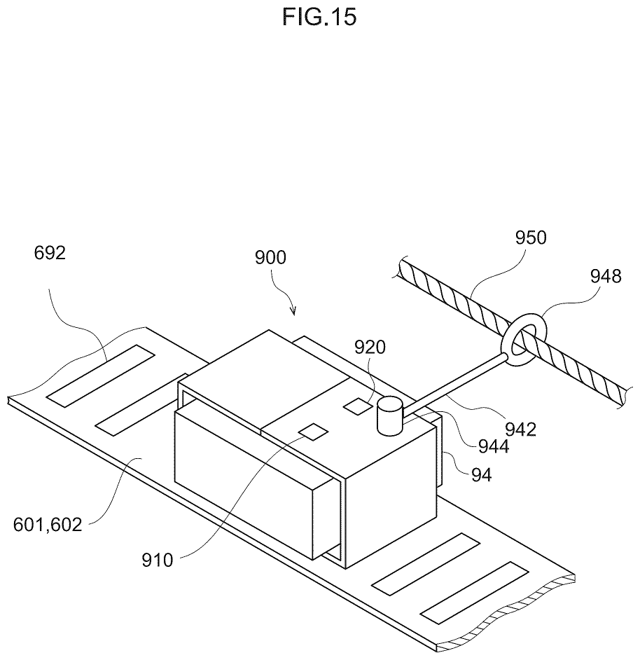

A configuration of the lock member is not limited thereto, and as illustrated in FIG. 15, the lock mechanism 900 may be obtained by the other end 948 of the lock member 942 being guided by a cable 950. The cable 950 is an example of a guide member provided along the horizontal conveyance lane 601 and the horizontal conveyance lane 602. The other end 948 of the lock member 942 is, for example, an annular member through which the cable 950 can pass.

This allows the lock mechanism 900 not only to lock the delivery object 94 such that the delivery object 94 cannot be detached from the horizontal conveyance lane 601 or the horizontal conveyance lane 602, but also to prevent the lock mechanism 900 itself from being detached from the horizontal conveyance lane 601 or the horizontal conveyance lane 602.

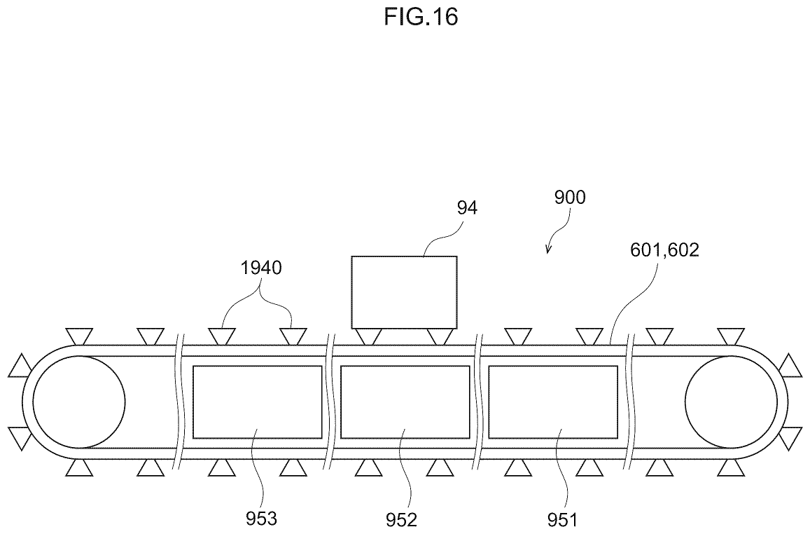

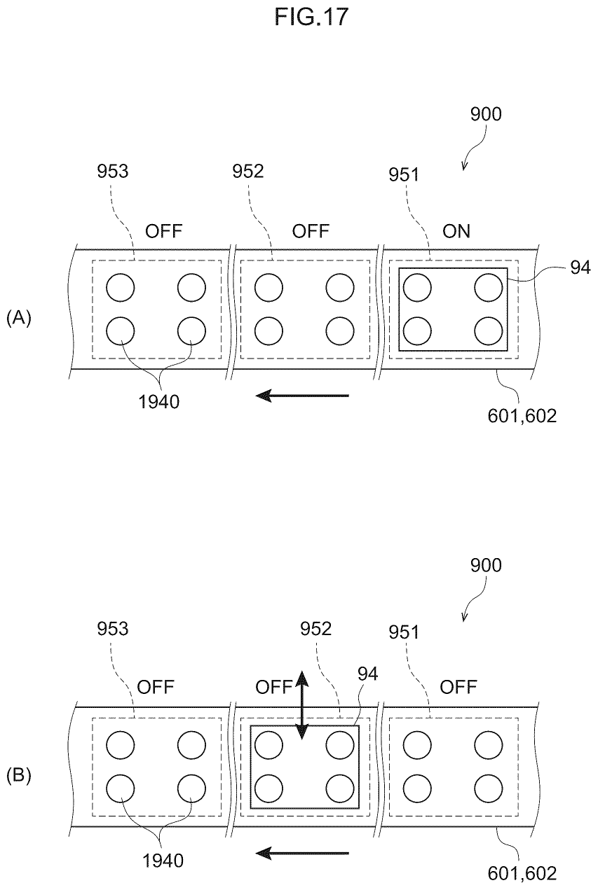

As illustrated in FIGS. 16 and 17, as the lock mechanism 900, a suction microcup 1940 may be provided on a conveyor provided in the horizontal conveyance lane 601 or the horizontal conveyance lane 602. Sucking the delivery object 94 with the microcup 1940 enables the delivery object 94 to be held and locked in the horizontal conveyance lane 601 or the horizontal conveyance lane 602.

For example, a plurality of suction devices 951, 952, and 953 are provided inside the conveyor. The suction devices 951, 952, and 953 are configured to apply a suction force to the microcup 1940 located on each thereof. Suction may be switched between ON and OFF for each microcup 1940. Alternatively, suction may be switched between ON and OFF for the microcup 1940 in a range corresponding to the size of the delivery object 94. A conveyor may be installed in each of a plurality of areas of the horizontal conveyance lane 601 or the horizontal conveyance lane 602.

Suction of the delivery object 94 by the microcup 1940 may occur only upon passage of the delivery object 94. In FIG. 17(A) and 17(B), it is assumed that the delivery object 94 is conveyed from a suction device 951 side to a suction device 953 side. It is assumed that a position of the suction device 952 is in front of the dwelling that is a destination of the delivery object 94 and positions of the suction devices 951 and 953 are in front of dwellings different from the destination. That is, the positions of the suction devices 951 and 953 are located in an area through which the delivery object 94 passes. In a case in which the delivery object 94 comes to the position of the suction device 951 or 953, suction is turned on and the delivery object 94 is sucked and locked by the microcup 1940. Consequently, it is possible to prevent the delivery object 94 from being detached from the horizontal conveyance lane 601 or the horizontal conveyance lane 602. Before and after the delivery object 94 passes, suction is turned off and the locking is released.

In the suction device 952 located in front of the dwelling that is a destination of the delivery object, the suction is turned off according to the authentication processing and the locking is released, so that the delivery object 94 can be extruded to the package yard 83a (FIG. 6). The delivery object 94 dispatched from the dwelling can be extruded from the package yard 38a onto the conveyor. In a case in which the position of the delivery object 94 is moved from the front of the dwelling that is a delivery destination to another area, the delivery object 94 is locked on the conveyor due to suction of the microcup 1940.

Whether suction can be performed may be determined depending on the type of package. Locking using suction may be performed in a case in which the package is the delivery object 94, and locking using suction need not be performed in a case in which the package is, for example, waste.

Next, a method of controlling a speed of the conveyance lane 600 will be described.

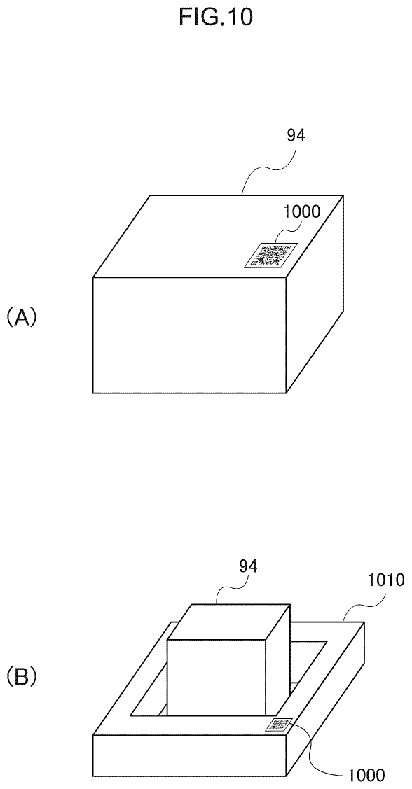

As illustrated in FIG. 10(A), a destination presentation portion 1000 that presents information indicating a destination of the delivery object 94 is attached to the delivery object 94. FIG. 10(A) illustrates an example in which the destination presentation portion 1000 is a two-dimensional code (for example, a QR code (registered trademark)). As illustrated in FIG. 5, a camera 560 that is a detection unit is provided around each dwelling 82. In a case in which the information of the destination presentation portion 1000 detected from an image captured by the camera 560 indicates that the dwelling 82 is a destination, the control device 540 performs control to reduce the conveyance speed of the conveyance lane 600, and stops the operation of the conveyance lane 600 in a case in which the delivery object 94 reaches the package yard 83 of the dwelling 82. The delivery object 94 is extruded to the package yard 83a by the extrusion device 660.

As illustrated in FIG. 10(B), the delivery object 94 may be conveyed on a tray 1010 dedicated to the dwelling 82 that is a destination of the delivery object 94. In this case, the destination presentation portion 1000 indicating that the destination of the delivery object 94 is the dwelling 82 is attached to the tray 1010.

As described above, the destination presentation portion 1000 that can be read from any direction is attached to the delivery object 94 or the tray 1010, and in a case in which the delivery object 94 approaches the destination dwelling 82, the destination presentation portion 1000 is detected from an image captured by the camera 560 around the destination dwelling 82, and the conveyance speed of the conveyance lane 600 is reduced. The case in which the destination presentation portion 1000 is a QR code (registered trademark) has been described as an example, but the invention is not limited thereto. An IC chip or a magnet may be used as the destination presentation portion 1000, and a sensor for reading the IC chip or the magnet may be used instead of the camera 560.

Instead of the destination presentation portion 1000, a content presentation portion that presents information regarding the delivery object may be attached to the delivery object 94 or the tray 1010, and the destination presentation portion 1000 may further function as a content presentation portion that presents information regarding the delivery object. In this case, the control device 540 may perform control to transmit a message including information of the destination presentation portion 1000 or the content presentation portion detected from the image captured by the camera 560 to a terminal of the dweller of the destination dwelling 82. As a result, it is possible to read, from the destination presentation portion 1000 or the content presentation portion, when a dweller of each dwelling has ordered the delivery object 94 that has arrived at the package yard 83a of each dwelling 82, what the contents are, and whether the delivery object is the same as the ordered product, and to notify the dweller of the read information.

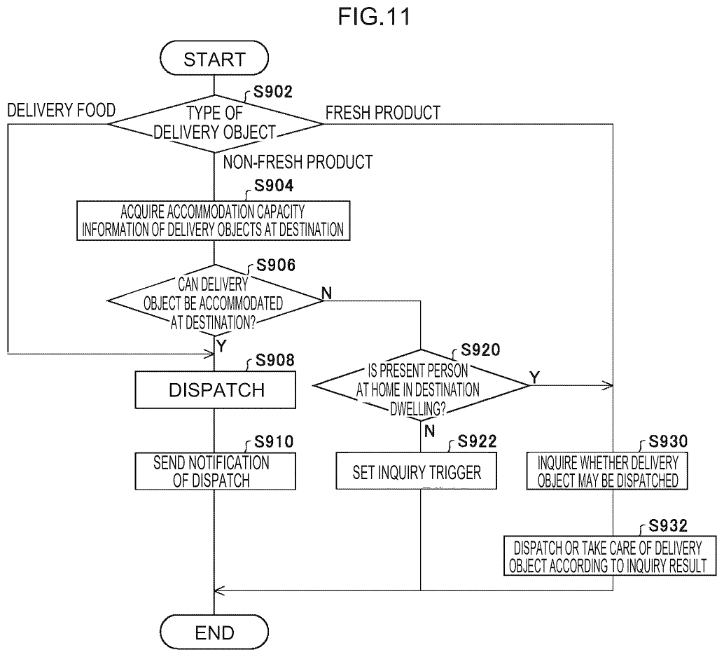

FIG. 11 is a flowchart illustrating a flow of distribution processing executed in the system 10. The processing in the flowchart of FIG. 11 is started in a case in which a delivery object addressed to the dwelling 82 arrives at the logistics base 84.

In S902, the server 40 refers to the “cargo type” of the delivery information to determine the type of delivery object. In a case in which it is determined that the type of the delivery object is a fresh product, in S930, the server 40 inquires of the dweller whether the delivery object may be dispatched. For example, the server 40 instructs a mobile terminal registered in advance for the destination of the delivery object to inquire whether the delivery object may be dispatched. The server 40 may instruct the home server of the destination of the dispatch object to inquire whether the delivery object may be dispatched.

Subsequently, in S932, in response to the inquiry result, the server 40 dispatches the delivery object or takes care of the delivery object at the logistics base 84, and ends the processing in the present flowchart. In a case in which the server 40 receives information for giving an instruction for a delivery time in response to the inquiry as to whether the delivery object may be dispatched, the server may schedule a dispatch time of the delivery object such that the delivery object will arrive at the destination at the delivery time for which the instruction is given, and may dispatch the delivery object according to the schedule. In a case in which the server 40 does not receive information for giving an instruction for a delivery time in response to the inquiry as to whether the delivery object may be dispatched, the inquiry may be repeatedly made every time a predetermined time elapses.

In a case in which it is determined in the determination of S902 that the type of the delivery object is a non-fresh product, in S904, the server 40 acquires accommodation capacity information of delivery objects at the destination. The accommodation capacity information includes information indicating whether it is possible to accommodate a new delivery object in the package yard 83 of the destination dwelling 82. The accommodation capacity information includes information indicating whether it is possible to store a new delivery object in the storage 510 of the destination apartment building 80. The accommodation capacity information may include information indicating whether it is possible to hold a new delivery object on the conveyance lane 500 of the destination apartment building 80.

In a case in which it is determined in S906 that the delivery object can be accommodated in the destination, the server 40 performs processing of dispatching the delivery object in S908. For example, the server 40 arranges the distribution vehicle 92 that distributes the delivery object, places the delivery object on the distribution vehicle 92, and instructs the distribution vehicle 92 to depart. In a case in which the distribution vehicle 92 departs, in S910, the server 40 notifies that the delivery object has been dispatched. For example, the server 40 notifies the mobile terminal registered in advance for the destination of the delivery object that the delivery object has been dispatched. The server 40 notifies the home server of the destination of the delivery object that the delivery object has been dispatched. Upon notification that the delivery object has been dispatched, the processing in the present flowchart is ended.

In a case in which it is determined in S906 that the delivery object cannot be accommodated in the destination, the server 40 determines in S920 whether there is a person at home in the destination dwelling. For example, the server 40 acquires position information of the mobile terminal registered in advance for the destination of the delivery object, and determines whether there is a person at home in the destination dwelling on the basis of the acquired position information and the position information of the destination dwelling. The server 40 may inquire of the home server of the dwelling that is a destination of the delivery object whether there is a person at home, and may determine whether there is a person at home in the destination dwelling by receiving information indicating whether there is a person at home in the destination dwelling from the home server.

In a case in which it is determined in the determination of S920 that there is a person at home in the destination dwelling, the server 40 causes the processing to proceed to S930. In a case in which it is determined in the determination of S920 that there is no person at home in the destination dwelling, when a new person at home is detected in the destination dwelling, in S922, the server 40 sets an inquiry trigger for making an inquiry as to whether the delivery object may be dispatched, and ends the processing in the present flowchart. In a case in which the inquiry trigger is set, the server 40 may instruct a mobile terminal registered in advance for the destination of the delivery to notify the server 40 in a case in which the position of the mobile terminal and the position of the destination dwelling are consistent with each other. The server 40 may instruct the home server of the dwelling that is a destination of the delivery object to notify the server 40 in a case in which a new person at home is detected in the destination dwelling 82. Upon receiving the notification from the mobile terminal or the home server, the server 40 may perform the processing in S930 and S932 in the flowchart of FIG. 9.

In a case in which it is determined that the type of the delivery object is a “delivery food” in the determination of S902, the server 40 causes the processing to proceed to S908.

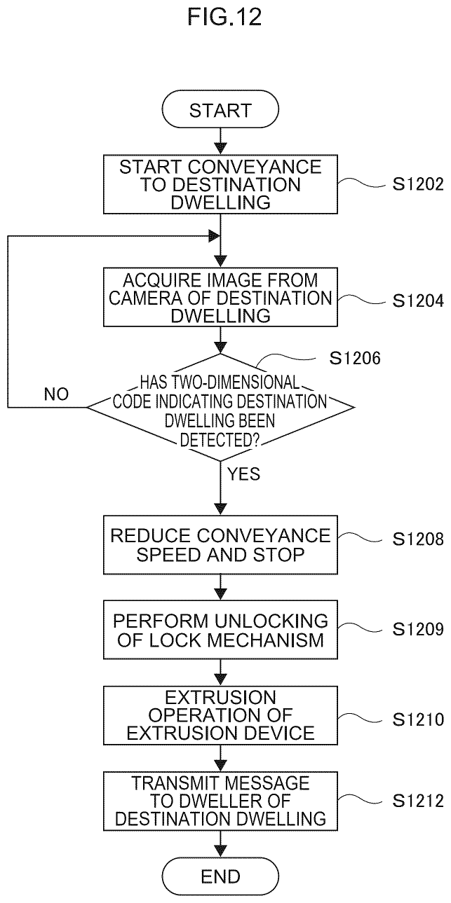

FIG. 12 is a flowchart illustrating a flow of delivery processing executed in the system 10. The processing in the flowchart of FIG. 12 is started in a case in which a delivery object addressed to the dwelling 82 arrives at the logistics base 84.

FIG. 12 is a flowchart illustrating a flow of delivery processing executed in the system 10. The processing in the flowchart of FIG. 12 is started in a case in which the delivery object 94 addressed to the dwelling 82 is moved from the distribution vehicle 92 to the conveyance lane 500.

In S1202, the control device 540 starts conveyance using the conveyance lane 500 such that the delivery object 94 is moved to the destination dwelling 82.

In S1204, the control device 540 acquires an image captured by the camera 560 provided around the destination dwelling 82.

In S1206, the control device 540 determines whether a two-dimensional code that is the destination presentation portion 1000 indicating that the dwelling 82 is the destination has been detected from the captured image. In a case in which the two-dimensional code that is the destination presentation portion 1000 indicating that the dwelling 82 is the destination has not been detected from the captured image, the processing returns to S1204. In a case in which the two-dimensional code that is the destination presentation portion 1000 indicating that the dwelling 82 is a destination has been detected from the captured image, the processing proceeds to S1208.

In S1208, the control device 540 performs control to reduce the conveyance speed of the conveyance lane 600, and stops the operation of the conveyance lane 600 in a case in which the delivery object 94 reaches the package yard 83 of the dwelling 82.

In S1209, the control device 540 controls to perform unlocking of the lock mechanism 900 gripping the delivery object 94.

In S1210, the control device 540 controls the extrusion device 660 to extrude the delivery object 94 to the package yard 83a.

In S1212, the control device 540 performs control to transmit a message including the information of the destination presentation portion 1000 detected from the image captured by the camera 560 to the terminal of the dweller of the destination dwelling 82.

As described above with reference to FIGS. 5 to 12, and the like, the system 10 can deliver a delivery object in a short time while preventing theft thereof. Therefore, a desired object can be delivered to a dweller of the apartment building 80 in a case in which the dweller wants the object.

The package yard 83 may be a space in front of the entrance of the dwelling 82. In the above description, a form in which the conveyance lane 500 includes a conveyor has been described, but a form in which a distribution robot delivers a delivery object through a distribution lane may be used.

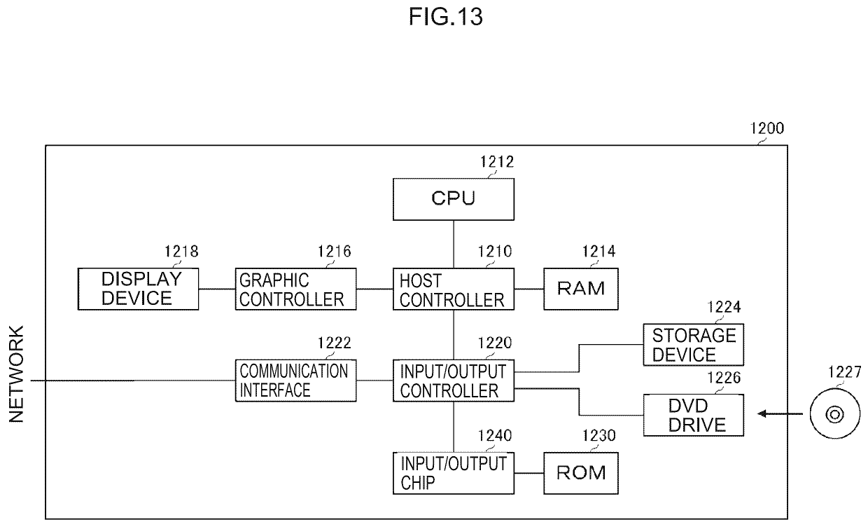

FIG. 13 schematically illustrates an example of a hardware configuration of a computer 1200 that functions as the server 40 or the control device 540. A program installed in the computer 1200 can cause the computer 1200 to function as one or more “units” of the device according to the present embodiment, or cause the computer 1200 to execute an operation associated with the device according to the embodiment or one or more “units” thereof, and/or cause the computer 1200 to execute a process according to the embodiment or a stage of the process. Such programs may be executed by a CPU 1212 to cause the computer 1200 to execute certain operations associated with some or all of the blocks in the flowcharts and block diagrams described herein.

The computer 1200 according to the embodiment includes a CPU 1212, a RAM 1214, and a graphic controller 1216, which are connected to each other via a host controller 1210. The computer 1200 also includes input/output units such as a communication interface 1222, a storage device 1224, a DVD drive 1226, and an IC card drive, which are connected to the host controller 1210 via an input/output controller 1220. The DVD drive 1226 may be a DVD-ROM drive, a DVD-RAM drive, or the like. The storage device 1224 may be a hard disk drive, a solid state drive, or the like. The computer 1200 also includes a ROM 1230 and legacy input/output units such as a keyboard, which are connected to the input/output controller 1220 via an input/output chip 1240.

The CPU 1212 operates according to programs stored in the ROM 1230 and the RAM 1214, thereby controlling each unit. The graphic controller 1216 acquires image data generated by the CPU 1212 in a frame buffer or the like provided in the RAM 1214 or itself, and causes the image data to be displayed on the display device 1218.

The communication interface 1222 communicates with other electronic devices via a network. The storage device 1224 stores programs and data used by the CPU 1212 in the computer 1200. The DVD drive 1226 reads a program or data from the DVD-ROM 1227 or the like and provides the program or data to the storage device 1224. The IC card drive reads a program and data from the IC card and/or writes the program and data to the IC card.

The ROM 1230 stores therein a boot program or the like executed by the computer 1200 at the time of activation and/or a program depending on hardware of the computer 1200. The input/output chip 1240 may also connect various input/output units to the input/output controller 1220 via a USB port, a parallel port, a serial port, a keyboard port, a mouse port, or the like.

The program is provided by a computer-readable storage medium such as the DVD-ROM 1227 or an IC card. The program is read from a computer-readable storage medium, installed in the storage device 1224, the RAM 1214, or the ROM 1230, which is also an example of a computer-readable storage medium, and executed by the CPU 1212. The information processing described in such a program is read by the computer 1200 and provides cooperation between the program and the various types of hardware resources. A device or a method may be configured by implementing an operation or processing of information according to use of the computer 1200.

For example, in a case in which communication is executed between the computer 1200 and an external device, the CPU 1212 may execute a communication program loaded in the RAM 1214 and instruct the communication interface 1222 to perform communication processing on the basis of processing described in the communication program. Under the control of the CPU 1212, the communication interface 1222 reads transmission data stored in a transmission buffer area provided in a recording medium such as the RAM 1214, the storage device 1224, the DVD-ROM 1227, or the IC card, transmits the read transmission data to the network, or writes reception data received from the network to a reception buffer area or the like provided on the recording medium.

The CPU 1212 may cause the RAM 1214 to read all or a necessary portion of a file or database stored in an external recording medium such as the storage device 1224, the DVD drive 1226 (DVD-ROM 1227), or the IC card, and may execute various types of processing on data in the RAM 1214. Next, the CPU 1212 may write back the processed data to the external recording medium.

Various types of information such as various types of programs, data, tables, and databases may be stored in a recording medium and subjected to information processing. The CPU 1212 may execute various types of processing on the data read from the RAM 1214, including various types of operations, information processing, condition determination, conditional branching, unconditional branching, information retrieval/replacement, and the like, which are described throughout the disclosure and specified by a command sequence of a program, and writes back the results to the RAM 1214. The CPU 1212 may search for information in a file, a database, or the like in the recording medium. For example, in a case in which a plurality of entries each having an attribute value of a first attribute associated with an attribute value of a second attribute is stored in the recording medium, the CPU 1212 may search for an entry in which the attribute value of the first attribute matches a specified condition from the plurality of entries, read the attribute value of the second attribute stored in the entry, and thus acquire the attribute value of the second attribute associated with the first attribute satisfying a predetermined condition.

The programs or software modules described above may be stored in the computer 1200 or a computer-readable storage medium near the computer 1200. A recording medium such as a hard disk or a RAM provided in a server system connected to a dedicated communication network or the Internet may be used as a computer-readable storage medium, and provides a program to the computer 1200 via the network.

Blocks in the flowcharts and the block diagrams in the embodiments may represent stages of a process in which an operation is performed or “units” of a device having a role of performing an operation. Specific stages and “units” may be implemented by a dedicated circuit, a programmable circuit supplied along with computer readable instructions stored on a computer readable storage medium, and/or a processor supplied along with computer readable instructions stored on a computer readable storage medium. Dedicated circuits may include digital and/or analog hardware circuits, and may include integrated circuits (ICs) and/or discrete circuits. Programmable circuits may include reconfigurable hardware circuits including, for example, AND, OR, XOR, NAND, NOR, and other logical operations, flip-flops, registers, and memory elements, such as field programmable gate arrays (FPGA) and programmable logic arrays (PLA).

Computer readable storage media may include any tangible device capable of storing instructions executed by a suitable device, and, as a result, a computer readable storage medium having instructions stored thereon has a product including instructions that may be executed to create means for executing operations designated in the flowcharts or block diagrams. Examples of the computer readable storage medium may include an electronic storage medium, a magnetic storage medium, an optical storage medium, an electromagnetic storage medium, and a semiconductor storage medium. More specific examples of the computer readable storage medium may include a Floppy (registered trademark) disk, a diskette, a hard disk, a random access memory (RAM), a read-only memory (ROM), an erasable programmable read-only memory (an EPROM or a flash memory), an electrically erasable programmable read-only memory (EEPROM), a static random access memory (SRAM), a compact disc read-only memory (CD-ROM), a digital versatile disk (DVD), a Blu-Ray (registered trademark) disk, a memory stick, and an integrated circuit card.

The computer readable instructions may include either source codes or object codes written in any combination of one or more programming languages, including assembler instructions, instruction-set-architecture (ISA) instructions, machine instructions, machine-dependent instructions, microcode, firmware instructions, state-setting data, or an object oriented programming language such as Smalltalk (registered trademark), or JAVA (registered trademark), C++, and conventional procedural programming languages such as the “C” programming language or similar programming languages.

The computer readable instructions may be provided to a processor of a general purpose computer, a special purpose computer, or another programmable data processing device, or a programmable circuit locally or via a local area network (LAN) or a wide area network (WAN) such as the Internet, in order to cause the processor of the general purpose computer, the special purpose computer, or another programmable data processing device or the programmable circuit to execute the computer readable instructions to generate means for executing operations designated in the flowcharts or the block diagrams. Examples of the processor include a computer processor, a processing unit, a microprocessor, a digital signal processor, a controller, and a microcontroller.

According to the disclosure, an improved delivery system, building, and distribution system can be provided.

Although the technology of the disclosure has been described by using each embodiment, the technology of the disclosure is not limited to the scope disclosed in each embodiment. It is apparent to those skilled in the art that various modifications or improvements can be made to the above embodiments. It is apparent from the description of the claims that modes to which such modifications or improvements are added can also be included in the technical scope of the disclosure.

The order of execution of each piece of processing of operations, procedures, steps, stages, and the like in the devices, the systems, the programs, and the methods shown in the claims, the specification, and the drawings can be realized in any order unless “before”, “prior to”, or the like is explicitly stated, and unless the output of the previous processing is used in the later processing. Even in a case in which the operation flow in the claims, the specification, and the drawings is described by using “first,”, “next,”, and the like for convenience, this does not mean that it is essential to perform in this order.

The disclosures of Japanese Patent Application No. 2023-29479 filed on Feb. 28, 2023, Japanese Patent Application No. 2023-90444 filed on May 31, 2023, and Japanese Patent Application No. 2023-90445 filed on May 31, 2023 are incorporated herein by reference in their entirety.

All of the documents, the patent applications, and the technical standards described in the present specification are incorporated herein by reference to the same extent as in a case in which each of the documents, the patent applications, and the technical standards were specifically and individually indicated to be incorporated by reference.

1. A delivery system for automatically delivering a delivery object to each of a plurality of dwellings in a building through a conveyance lane provided in the building, the delivery system comprising:
a control unit that moves a delivery object that is being delivered through the conveyance lane from the conveyance lane to a delivery object yard provided in a dwelling that is a destination of the delivery object in a case in which the delivery object that is being delivered through the conveyance lane passes through the delivery object yard; and
a lock mechanism that locks the delivery object such that the delivery object is not detached from the conveyance lane, and unlocks the delivery object according to authentication processing.

2. The delivery system according to claim 1, wherein the lock mechanism includes a suction member provided in the conveyance lane and a suction device that generates a suction force on the suction member, the delivery object is sucked by the suction member and locked not to be detached from the conveyance lane at a delivery object yard different from the delivery object yard of the destination dwelling, and is unlocked according to authentication processing at the delivery object yard of the destination dwelling.

3. The delivery system according to claim 1, wherein the lock mechanism performs authentication processing by using a two-dimensional code presented by a dweller.

4. The delivery system according to claim 1, wherein a destination presentation portion that presents information indicating a destination of the delivery object is attached to the delivery object, and
the control unit performs control to reduce a conveyance speed of the conveyance lane in a case in which the information of the destination presentation portion detected by a detection unit provided around the dwelling indicates that the dwelling is the destination.

5. The delivery system according to claim 1, wherein a destination presentation portion that presents information indicating a destination of the delivery object is attached to a tray of the delivery object, and
the control unit performs control to reduce a conveyance speed of the conveyance lane in a case in which the information of the destination presentation portion detected by a detection unit provided around the dwelling indicates that the dwelling is the destination.

6. The delivery system according to claim 1, wherein a rotation mechanism that rotates in a direction orthogonal to a conveyance direction is provided at each position of the conveyance lane, and
the control unit controls an extrusion device provided at a position corresponding to a delivery object yard of each of the plurality of dwellings to extrude the delivery object to the delivery object yard provided in a dwelling that is a destination of the delivery object, the extrusion device extruding the delivery object in the direction orthogonal to the conveyance direction of the conveyance lane.

7. The delivery system according to claim 1, wherein a content presentation portion that presents information regarding the delivery object is attached to the delivery object, and
the control unit controls to transmit the information of the content presentation portion detected by a detection unit provided around the dwelling to a terminal of a dweller of the dwelling.

8. The delivery system according to claim 1, wherein the building is provided with a storage that temporarily stores a delivery object addressed to a dwelling in the building and includes a refrigerating facility, and
in a case in which the delivery object is a food product requiring refrigeration and the delivery object is placed in the delivery object yard for a certain time or more, the control unit returns the delivery object to the conveyance lane and moves the delivery object to the storage.

9. The delivery system according to claim 1, wherein the building is provided with a storage that temporarily stores a delivery object addressed to a dwelling in the building, and
the control unit stores the delivery object in the storage in a case in which the delivery object is unable to be placed in the delivery object yard of a dwelling that is a destination of the delivery object.

10. (canceled)

11. (canceled)

12. The delivery system according to claim 1, wherein before a delivery object addressed to a dwelling in the building is dispatched from a logistics base outside the building, the control unit determines whether the delivery object is able to be placed in a delivery object yard provided in a destination dwelling, and in a case in which it is determined that the delivery object is able to be stored in the delivery object yard, the control unit dispatches the delivery object from the logistics base.

13. (canceled)

14. (canceled)

15. The delivery system according to claim 1, wherein before a delivery object addressed to a dwelling in the building is dispatched from a logistics base outside the building, the control unit further determines whether the delivery object is able to be held on the conveyance lane, and
the control unit dispatches the delivery object from the logistics base in a case in which it is determined that the delivery object is able to be held on the conveyance lane.

16. The delivery system according to claim 1, wherein before a prescribed type of delivery object addressed to a dwelling in the building is dispatched from a logistics base outside the building, the control unit inquires of a dweller of a destination dwelling whether to deliver the delivery object, and in a case in which a delivery instruction is received from the dweller, the control unit dispatches the delivery object from the logistics base.

17. The delivery system according to claim 1, wherein in a case in which a dispatch object is dispatched from the dwelling, the control unit moves the dispatch object placed in the delivery object yard from the delivery object yard to the conveyance lane.

18. (canceled)

19. A building comprising:
the delivery system according to claim 1; and
the conveyance lane.

20. (canceled)

21. A distribution system comprising:
the delivery system according to claim 1, and
a server that manages transportation of a delivery object using a self-driving vehicle from a logistics base outside the building to the building.
